(19) United States
(12) Patent Application Publication
(10) Pub. No.: US 2011/0035276 A1
(43) Pub. Date: Feb. 10, 2011

(54) Automatic Campaign Optimization for Online Advertising Using Return on Investment Metrics

(76) Inventors: Arpita Ghosh, Santa Clara, CA (US); Mohammad Mahdian, Santa Clara, CA (US)

Correspondence Address: Stattler-Suh PC, 60 SOUTH MARKET, SUITE 480, SAN JOSE, CA, 95113, US

(21) Appl. No.: 12/535,879

(22) Filed: Aug. 5, 2009

(51) Int. Cl. G06Q 30/00

(52) U.S. Cl. 705/14.46

(57) ABSTRACT

A method for optimizing quantitative return-on-investment performance in an online advertising campaign. The advertising campaign has a finite campaign period and a finite spending budget within a system that includes a bidding facility for bidding on a plurality of advertising slots. The method seeks to optimize performance of the campaign according to an objective function that includes a marginal return on investment variable, which variable is maintained throughout a series of iterations. Techniques are disclosed for capturing campaign parameters and constraints from advertisers, and mathematical techniques are used in determining a selected advertising slot upon which to bid at each iteration. A tracking system provides a history of winning bids and forecast of inventory. After bidding, the value of the marginal return on investment variable is changed based on the results of the bidding. The next bidding operations are based on the value of the marginal return on investment variable.

### FIELD OF THE INVENTION

The present invention is directed towards quantitative optimization of bidding for online advertising, based on quantitative campaign objectives.

### BACKGROUND OF THE INVENTION

The marketing of products and services online over the Internet through advertisements is big business. Advertising over the Internet seeks to reach individuals within a target set having very specific demographics (e.g. male, age 40-48, graduate of Stanford, living in California or New York, etc). This targeting of very specific demographics is in significant contrast to print and television advertisement that is generally capable only to reach an audience within some broad, general demographics (e.g. living in the vicinity of Los Angeles, or living in the vicinity of New York City, etc). The single appearance of an advertisement on a web page is known as an online advertisement impression. Each time a web page is requested by a user via the Internet represents an impression opportunity to display an advertisement in some portion of the web page (e.g. a “slot” or “spot”) to the individual Internet user. Often, there may be significant competition among advertisers for a particular impression opportunity, i.e. to be the one to provide that advertisement impression to the individual Internet user.

To participate in this competition, some advertisers define one or more campaigns, including authorization to bid on certain impression opportunities (e.g. authorization to bid in an auction) in the hope of winning the competition. Generally, a campaign will include limits or targets on spending and/or limits related to the campaign time period (e.g. spend no more than $1000 per day, spend $100,000 within the month of June). An advertiser may further specify desired targeting criteria, which targeting criteria may include a keyword, multiple keywords, key phrases, or other targeting criteria. For example, an advertiser may wish to present advertising messages to users who search for any keyword or keywords in a campaign. In modern Internet advertising systems, competition for showing an advertiser's message in an impression is often resolved by an auction, and the winning bidder's advertisements and/or messages are shown in the available spaces within the impression. Indeed online advertising and marketing campaigns often rely, at least partially, on an auction process where any number of advertisers book contracts to submit and authorize highest bids corresponding to targeting characteristics (e.g. a search keyword, a set of keywords, bid phrases, or various demographics). The advertisements corresponding to the auction winner's criteria are presented in a slot within the impression.

Considering that (1) the actual existence of a web page impression opportunity suited for displaying an advertisement is not known until the user clicks on a link pointing to the subject web page, (2) the price of a winning bid changes very frequently (minute by minute, day by day), and (3) the bidding process for selecting advertisements must complete before the web page is actually displayed, it then becomes clear that the bidding process should be carried out automatically. More specifically, and particularly referring to the mechanism of bidding, traditional bidding strategies (e.g. bid more aggressively if the budget is forecasted to be under spent by the end of the campaign period, or bid aggressively but stop bidding when a daily budget maximum has been reached) often do not yield optimized results over the period of the campaign as a whole, and moreover simple traditional bidding strategies do not account for any specific measurable utility to be included in the bid calculations. Thus, a system to automate quantitative optimization of bidding for online advertising based on a quantitative utility metric (e.g. a return on investment metric) is needed.

Other automated features and advantages of the present invention will be apparent from the accompanying drawings and from the detailed description that follows below.

### SUMMARY OF THE INVENTION

A method for optimizing quantitative performance in an online advertising campaign having a finite campaign period and a finite campaign spending budget. Bidding on online advertising employs a bidding facility for bidding on a plurality of ranked advertising slots for a particular advertising opportunity. The method uses mathematical techniques to define an objective function for campaign performance (e.g. return on investment). A value for a marginal return on investment variable is constantly maintained. Using the value of the marginal return on investment variable one or more particular advertising slots can be selected for bidding. A system for maintaining a history of prior performance of similar advertising slots is employed, as is a system for forecasting inventory such that a particular bid for a particular slot can be known to be a winning bid within a statistical certainty. Embodiments calculate a bid amount corresponding to the selected opportunity slot and capture the results of the bidding at auction. The results of the bidding, for example the bid amount in combination with the fact that the auction was won or the fact that the auction was lost is used to modify the marginal return on investment variable. A lost auction might indicate more aggressive spending if absent more aggressive spending other campaign constraints such as budget might not be satisfied within the campaign period. In the next iteration, the method uses the value of the updated marginal return on investment variable for selecting one or more particular advertising slots, for which slots the effect of winning an auction based a calculated bid can be known within a mathematical certainty to contribute to optimizing the quantitative performance results of the campaign.

### BRIEF DESCRIPTION OF THE DRAWINGS

The novel features of the invention are set forth in the appended claims. However, for purpose of explanation, several embodiments of the invention are set forth in the following figures.

FIG. 1 is a plot of volume of activity plotted against reach of subject matter.

FIG. 2 is a block diagram of a system for automatic campaign optimization for online advertising using return on investment metrics, according to one embodiment.

FIG. 3A is a form for collecting information regarding a search marketing campaign, according to one embodiment.

FIG. 3B is a form for collecting information about the advertiser's specific products or services by keyword for use within a search marketing campaign, according to one embodiment.

FIG. 3C is a form for collecting information about the advertiser's target customers by geographic location for use within a search marketing campaign, according to one embodiment.

FIG. 3D is a form for collecting and reporting an inventory of keywords for use within a search marketing campaign, according to one embodiment.

FIG. 3E is a form for collecting information regarding spending limits within a search marketing campaign, according to one embodiment.

FIG. 3F is a form for collecting information regarding objectives and constraints within a search marketing campaign, according to one embodiment.

FIG. 3G is a form for displaying information regarding a plurality of search marketing campaigns, according to one embodiment.

FIG. 4 is a comparison of cost versus utility for a particular keyword, according to one embodiment.

FIG. 5 is a plot of cost versus utility for particular keywords, according to one embodiment.

FIG. 6 is a plot of cost versus utility for particular keywords and showing a marginal return on investment metric as a slope, according to one embodiment.

FIG. 7 is a flowchart of a method for use within a system for automatic campaign optimization for online advertising using return on investment metrics, according to one embodiment.

FIG. 8 is a block diagram of a system for automatic campaign optimization for online advertising using return on investment metrics, according to one embodiment.

FIG. 9 is a flowchart of a method for optimizing quantitative performance in an online advertising campaign using return on investment metrics, according to one embodiment.

FIG. 10 is a diagrammatic representation of a machine in the exemplary form of a computer system, within which a set of instructions may be executed, according to one embodiment.

### DETAILED DESCRIPTION

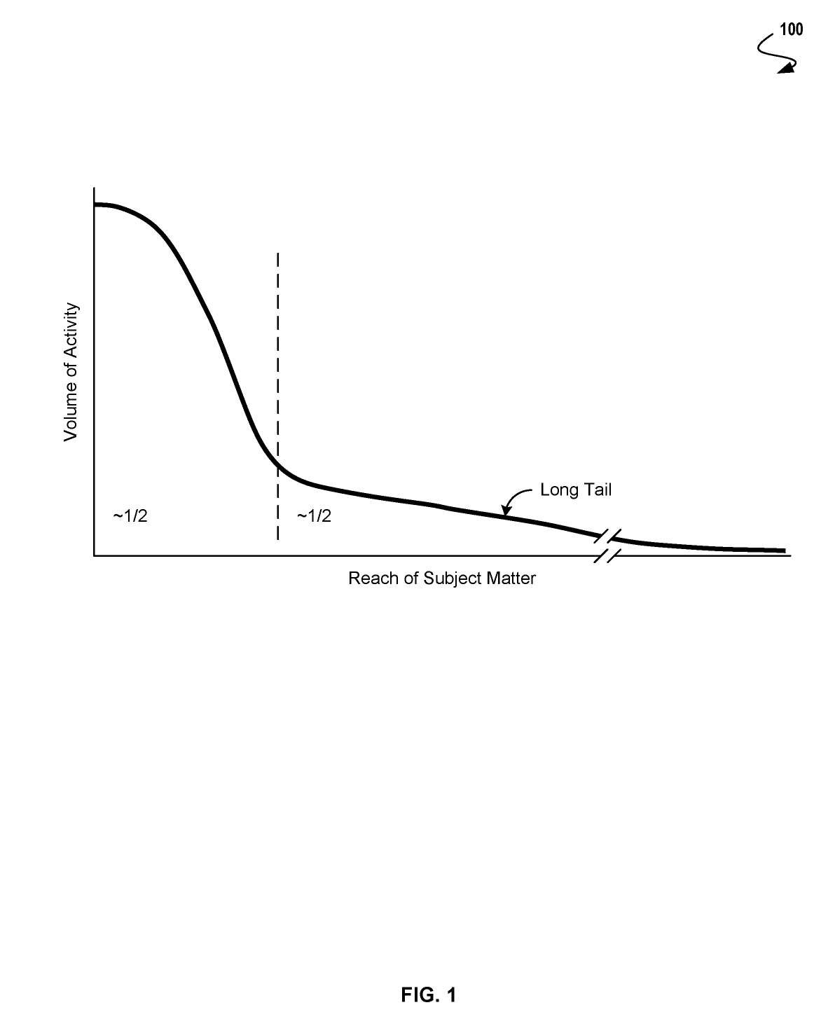

The growth of the online advertising business during the past few years has relied to a large extent on reaching advertising target audiences and individuals who are situated within some portion of the “long tail” of subject matter reach. As shown in the long tail plot 100 of FIG. 1, the nature of subject matter comprising the long tail is such that there is a low volume of activity (e.g. sales transactions, inquiries, etc) corresponding to a particular subject matter area. For commercial reasons then, reaching the corresponding audiences is typically the province of many small- to medium-sized advertisers, each with relatively modest spending limits for advertising. Moreover, such advertisers do not have the technology background or expertise or staff to dynamically optimize their advertising campaigns in an environment where many variables (such as query volumes, impression volumes, prices, etc) are rapidly changing.

Within the context of bidding for online advertising, the advertiser seeks to match the advertiser's advertisement or message to relevant content (e.g. a search results page). For example, a manufacturer of motor scooters might establish an advertising campaign that attempts to place the manufacture's advertisement on the same page as the search results related to “motor scooters”. Furthermore, the manufacturer would bid for a more prominent spot on the search results page in the hope that an Internet user would notice the manufacturer's advertisement and click on the advertisement or message for more information. Measuring the number of Internet user clicks as a percentage of the total number of impressions (e.g. measuring a click-through rate, CTR) is one way to measure the effectiveness of an advertising campaign, however other measurements of effectiveness of an advertising campaign may include calculating overall return on investment (ROI) of the campaign. Such optimization in the context of an online advertising campaign generally includes constraints such as overall budget constraints, daily min-/max-spend, min-/max-number of clicks, targeting particular slots, maximum cost-per-click, various budget over time constraints, etc Therefore, a major component of a campaign optimization tool is an algorithm for optimally allocating the budget of the advertiser across advertising opportunities, yet observing the myriad constraints. In various embodiments described herein, a method for optimally allocating the budget of the advertiser across advertising opportunities is performed repeatedly and on a periodic basis; and when performed, it updates certain campaign variables (e.g. bids based on the traffic volume and other variables characterizing the current bid landscape). The fact that the aforementioned method is performed periodically (e.g. once every six hours) and it optimizes based on the current bid landscape (e.g. volume of forecasted/estimated inventory, winning bid price, etc) allows it to react to changes in the conditions of the market and changes in other advertisers' bids. For example on a slow day with low traffic, bids might be increased so as to keep spending on track with exhausting the budget within the specified period.

### A Campaign Optimizer Engine

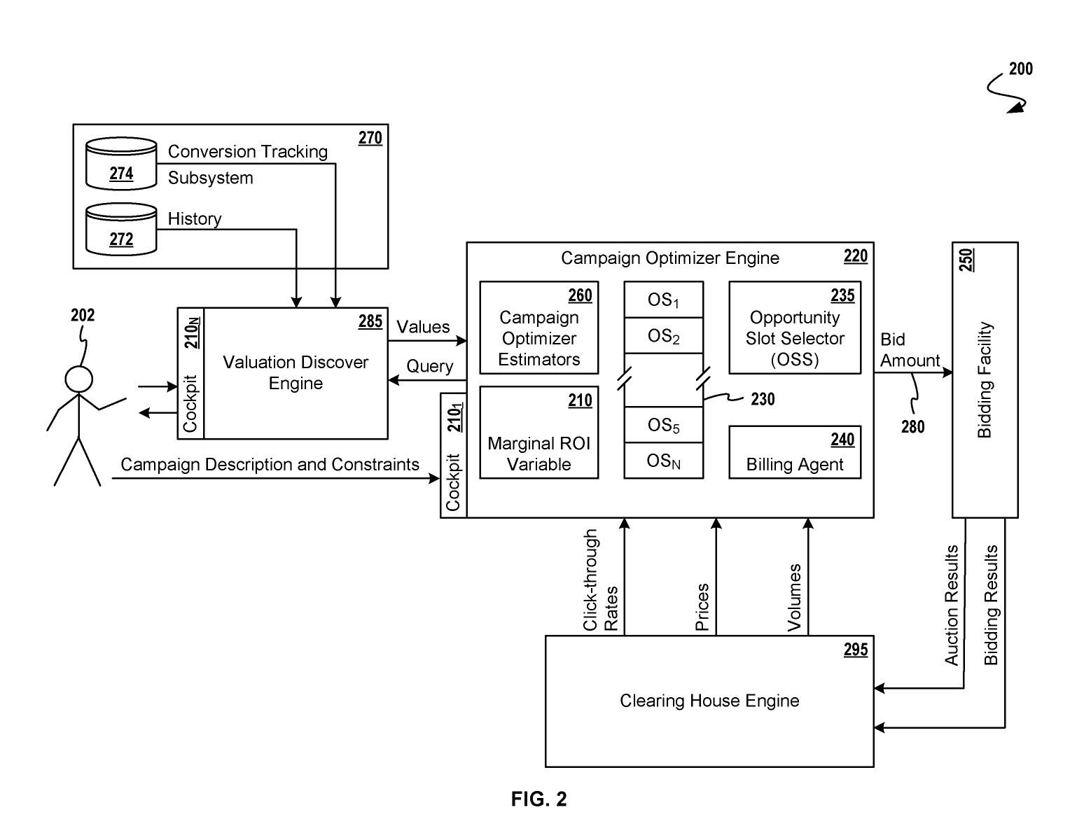

FIG. 2 is a block diagram of a system for automatic campaign optimization for online advertising using return on investment metrics, according to one embodiment. As shown, a campaign optimizer engine 220 takes inputs from an advertiser 202 in the form of a campaign description, inputs from a valuation discovery engine 285, and inputs from a clearing house engine 295. The campaign optimizer engine 220 performs calculations and performs other processes and tasks, and outputs to a bidding facility 250.

The campaign optimizer engine 220 processes a wide range of information from its input sources (e.g. from an advertiser 202, from a valuation discovery engine 285, or from a clearing house engine 295). In the embodiment shown, such information includes:
Advertiser-specified campaign variables that comprises the advertisers assigned utility (value per-click, value-per-conversion, etc) corresponding to an advertising opportunity slot,
Historical estimates of click-through rates (CTR), conversion rates, and other tracking information pertaining to an advertising opportunity slot,
Calculated estimates of the price of each slot, and
Estimates of forecasts of impression volumes, possibly including specific slot volumes.

On the basis of calculations performed within the campaign optimizer engine 220, the campaign optimizer engine 220 places bids on behalf of the advertiser, which bids seek to optimize the utility (e.g. overall value of results, overall return on investment, etc) of the campaign to the advertiser.

As shown in FIG. 2, the system for automatic campaign optimization for online advertising using return on investment metrics 200 queries a valuation discovery engine 285 in order to retrieve historical trend and/or estimated trend information. A valuation discovery engine 285 may itself employ subsystems, databases, models, tools, or techniques such as conversion tracking subsystems 270, history databases 272, conversion databases 274, pay-per-action models, keyword suggestion tools, or other techniques to help the advertiser discover profitable advertising opportunities (e.g. a keyword or combination of keywords, key phrases, etc) and thus provide sufficient information or forecasts for estimation of values per click variables and/or return on investment variables. Having such forecasts and/or estimates, the advertiser may then more effectively define the parameters of a campaign's constraints, and may thus define appropriate metrics for optimization during the prosecution of such an advertising campaign. Furthermore, the campaign optimizer engine can interact with learning components that learn the click-through rates of the advertiser through exploration/exploitation strategies.

For purposes of more easily understanding the disclosure herein, it is important to note that, in exemplary embodiments, the campaign optimizer engine 220 operates to act on behalf of a single advertiser, as opposed to performing a global (i.e. system-wide), advertising optimization. In other words, the objectives of the optimization techniques within the embodiments seek to optimize the results of actions taken within a particular advertiser's campaign.

Performing calculations and taking actions are further described infra, whereby the campaign optimizer engine 220 includes a marginal return on investment variable 210, a plurality of campaign optimizer estimators 260, an opportunity slot selector 235, (which operates on an array of opportunity slots OS₁-OS_{N} 230), and a bidding agent 240. The aforementioned modules operate cooperatively to calculate and provide a bid amount 280 to the bidding facility 250. As shown, the present system 200 includes one or more advertiser interfaces 210 (e.g. advertiser interfaces shown as cockpits 210₁,-210_{N}) which advertiser interfaces facilitate man/machine interaction and permits an advertiser (e.g. an advertiser 202) to enter parameters, and view calculations, forms, and reports.

As earlier mentioned, the effectiveness of an advertising campaign might be measured using a return on investment calculation. That is, by calculating quantitative results of the campaign (for example, by comparing additional profit gained by sales of units corresponding to clicks or other events directly related to the advertisements or messages) to the cost of advertising to obtain those results, a return on investment metric can be defined and tracked over the course of the campaign. This type of return on investment is often calculated at the end of some measurement period within the campaign (e.g. the first three weeks returned a 7× ROI, the last three weeks returned a 22× ROI). However the results so expressed as covering a period are merely an integration of the results obtained over each and every transaction that contributes to the return on investment calculation. If each and every transaction that contributes to the return on investment calculation were optimized, then the results over any period in the campaign can be thought to be optimized. Thus the problem of optimizing a campaign can be thought of in terms of optimizing each and every transaction that contributes to the return on investment calculation. Accordingly, the campaign optimizer engine 220 includes a marginal return on investment variable 210, which variable is used in calculations and decision-making that affects any transaction that contributes to the return on investment calculation.

One embodiment of a system for automatic campaign optimization for online advertising uses return on investment metrics as follows:
Let k refer to a particular aspect of a target (e.g. a keyword, a demographic, or any other aspect the advertiser deems to be relevant to the advertiser's products, services or messaging objectives).
Let i refer to a particular impression opportunity that corresponds to at least one targeting aspect k of the advertiser's campaign (e.g. the search results from a keyword-based search).
Let vᵢ refer to the value that the advertiser ascribes to a result (e.g. a click or other conversion) from within a particular impression opportunity (e.g. keyword results page, or Internet property publication of an impression using the keyword k).
Let j refer to a particular order ad slot within an impression opportunity i.
Let pᵢⱼ refer to the estimated price (e.g. a winning bid) corresponding to impression opportunity i and ad slot j. That is, pᵢⱼ refers to the estimated price that the advertiser has to pay to get the j'th slot within impression opportunity i. Since generally an auction mechanism is used to price the slots, this price generally corresponds to the j'th highest bid from other advertisers on this keyword. This estimate can be computed by observing the bid landscape at that moment, or can be computed by using historical data, as is discussed infra.
Let ctrᵢⱼ refer to estimated click-through rate of the advertiser's ad, were it to be placed in a delivered impression opportunity i and in ad slot j.
Let freqᵢ refer to estimated inventory expressed as the frequency at which the impression opportunity i is expected to occur in the future (e.g. 120,000 impressions forecasted to occur within the next 30 days).

### Techniques for Campaign Objective and Constraint Definition

In various embodiments, advertisers are given the choice to use or not to use the system for automatic campaign optimization for online advertising using return on investment metrics. When an advertiser does opt-in to use the system for automatic campaign optimization, various embodiments serve to collect information from the advertiser, which information defines the campaign, and in particular defines quantitative campaign objectives and constraints.

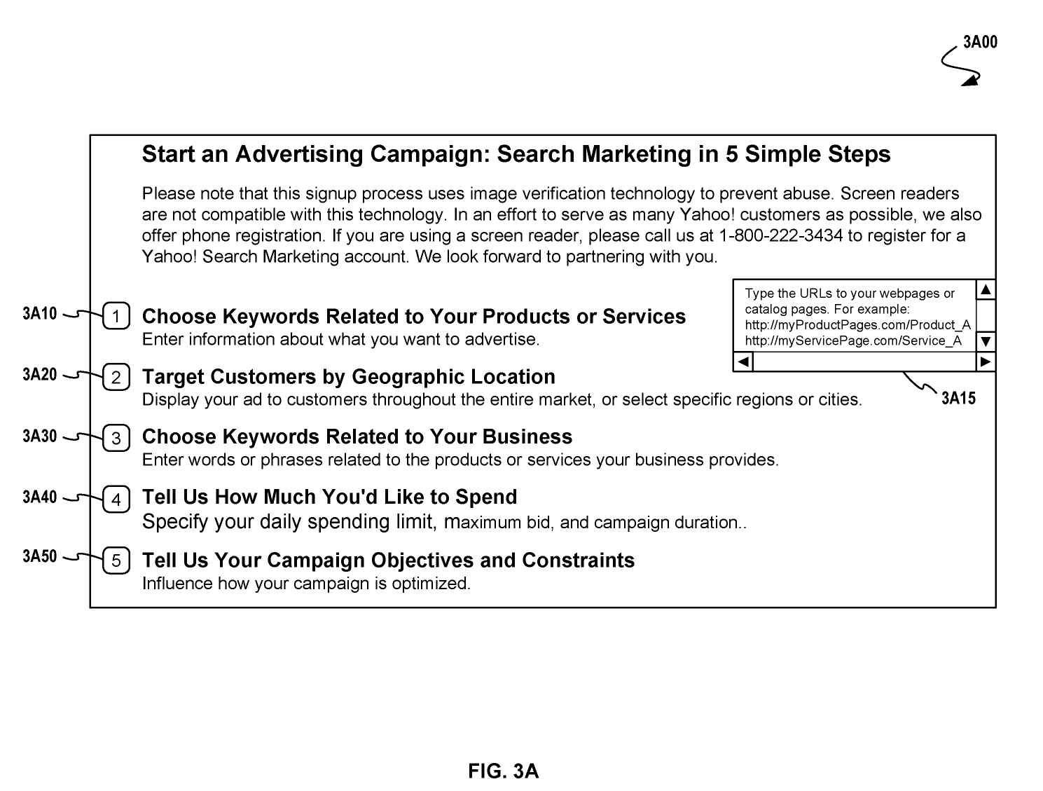

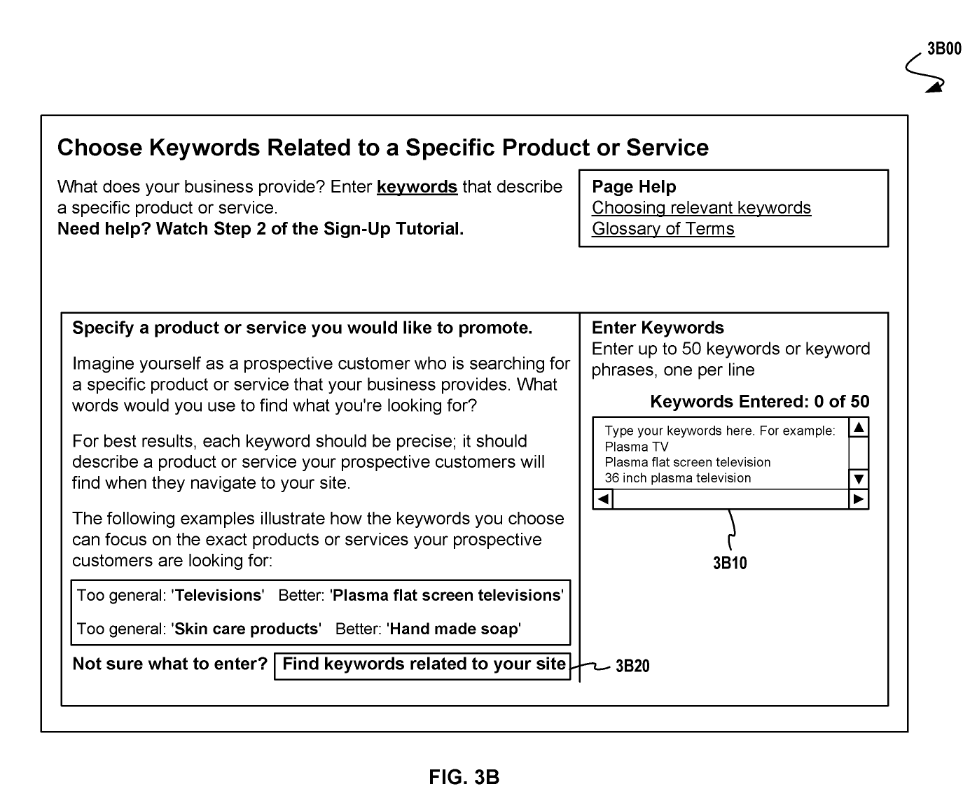

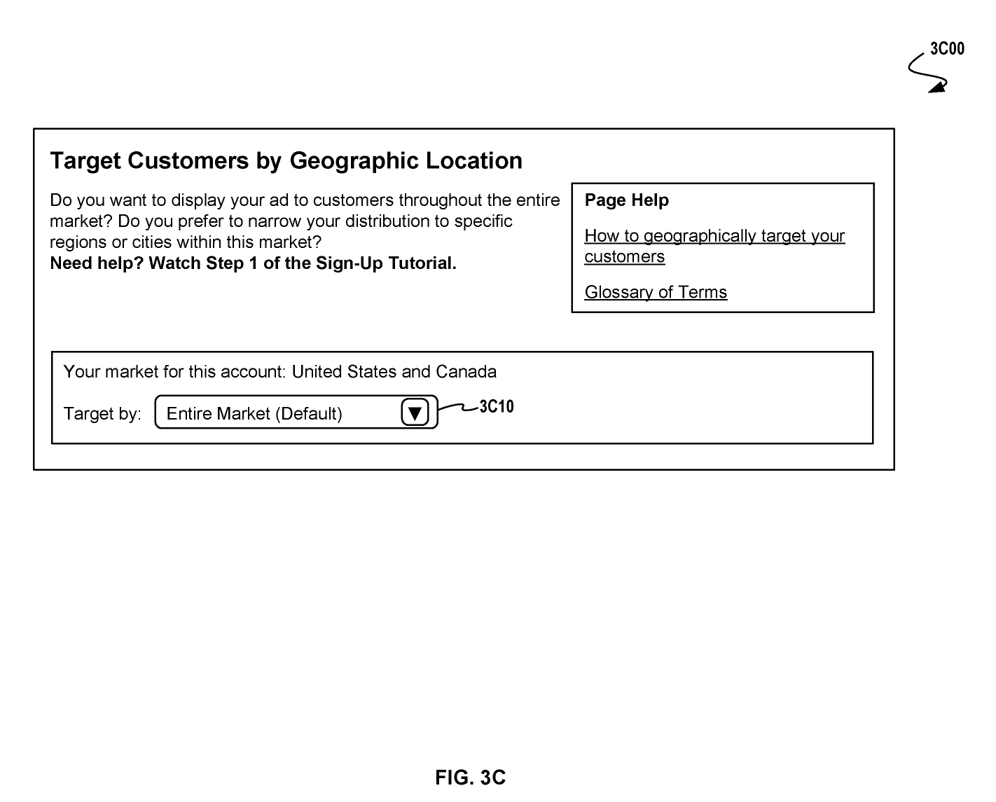

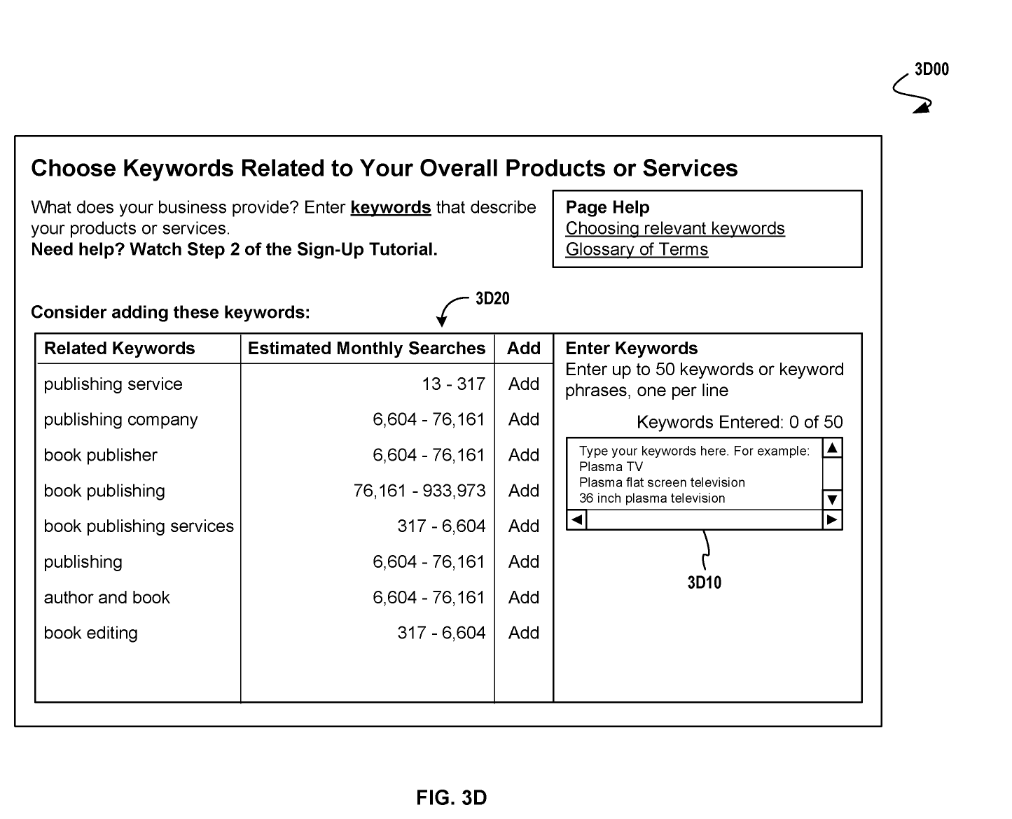

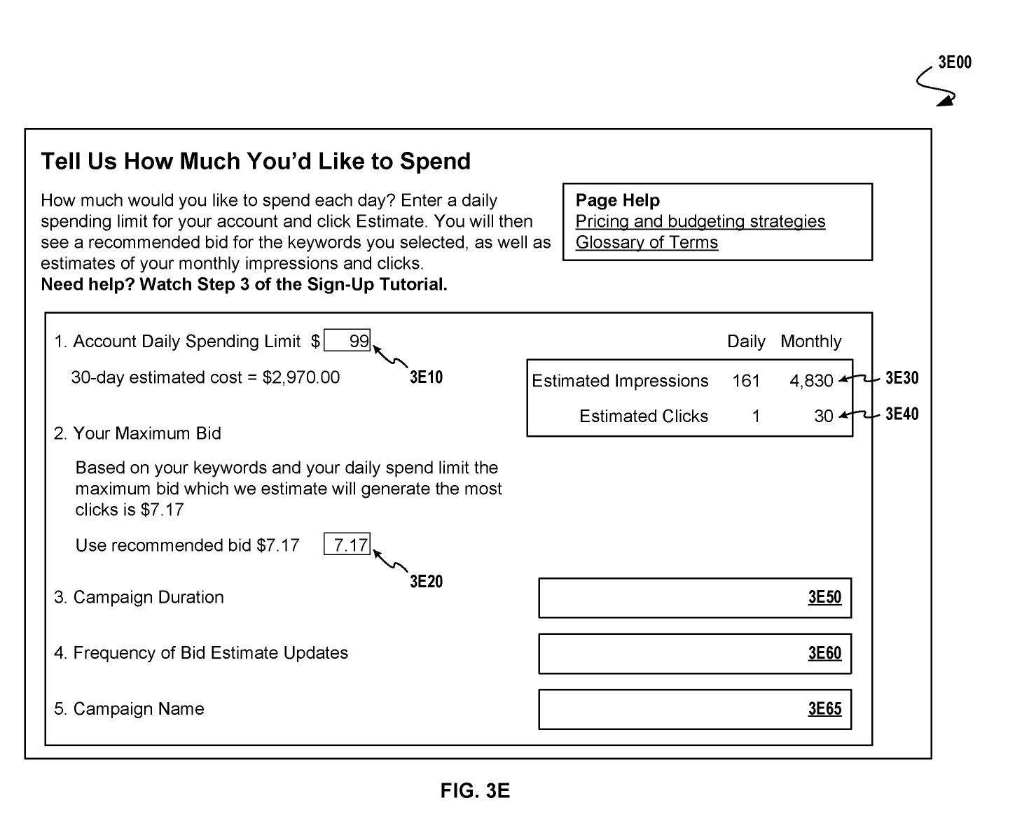

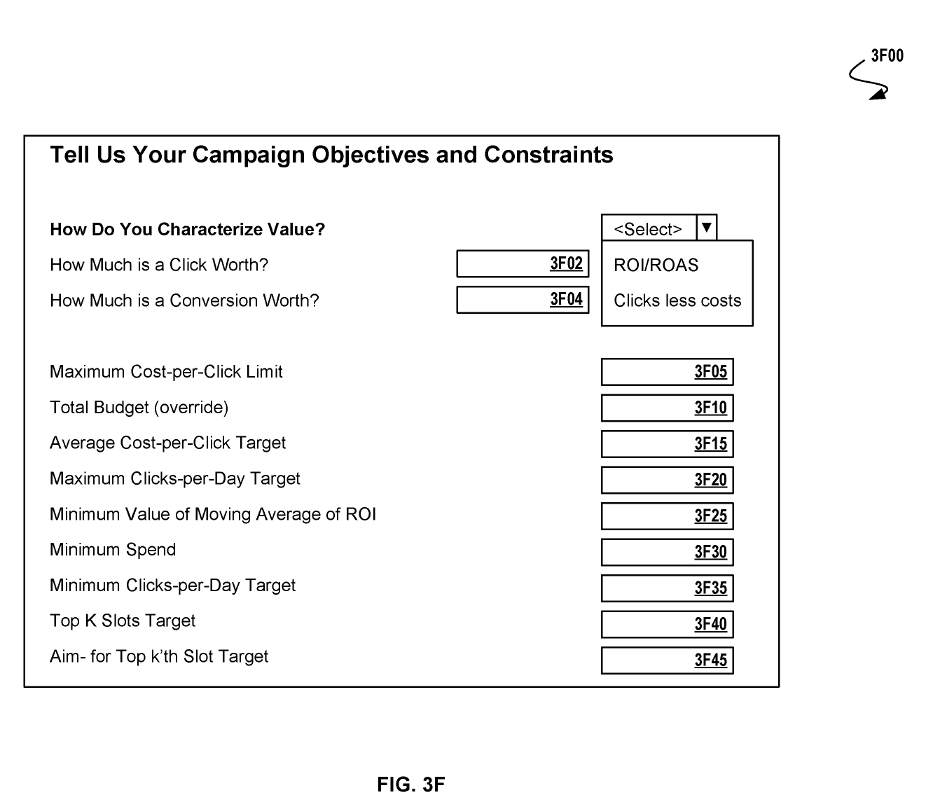

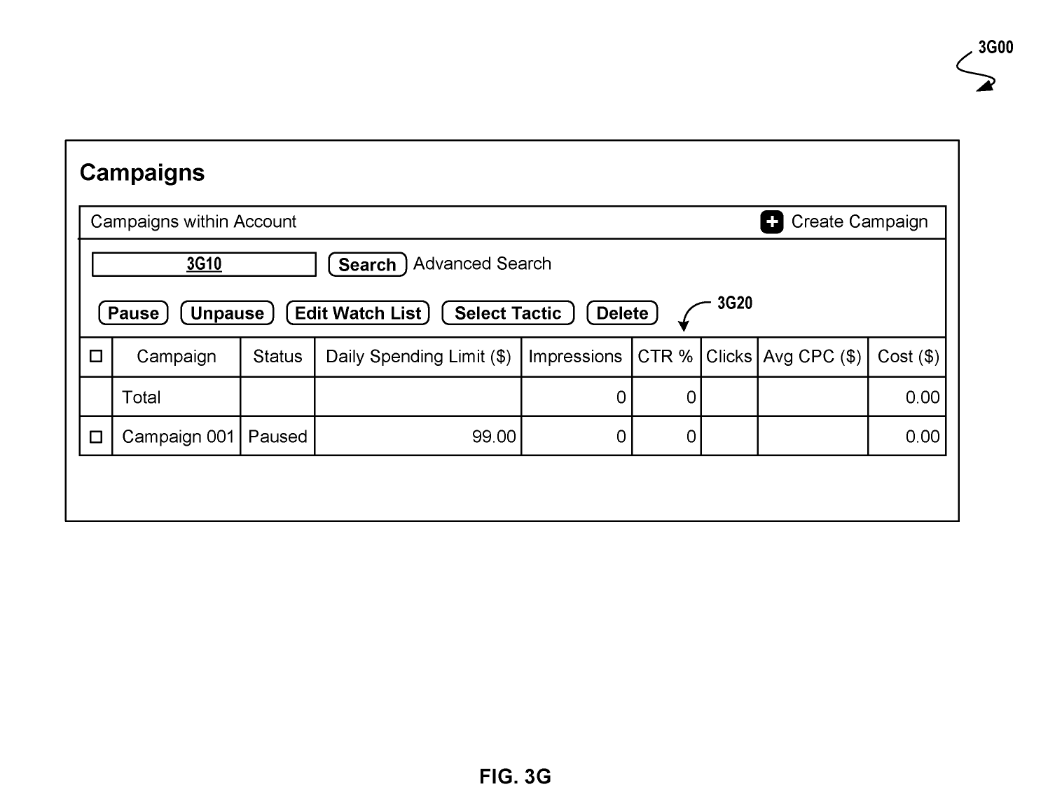

FIG. 3A is a form for collecting information regarding a search marketing campaign, according to one embodiment. As shown, the form for collecting information regarding a search marketing campaign 3A00 seeks to guide an advertiser through a series of questionnaires for defining campaign objectives and constraints. In particular, the question #1 3A10 (also see discussion for FIG. 3B), in conjunction with screen device 3A15, serves to collect information about an advertiser's specific products or services by keyword. The question #2 3A20 (also see discussion for FIG. 3C) serves to collect information about the advertiser's target customers by geographic location. The question #3 3A30 (also see discussion for FIG. 3D) serves to collect information about an advertiser's overall products or services (an inventory) by keyword. The question #4 3A40 (also see discussion for FIG. 3E) serves to collect information about the advertiser's target budget. The question #5 3A50 (also see discussion for FIG. 3F) serves to collect information about other of the advertiser's campaign objectives and constraints.

FIG. 3B is a form for collecting information about the advertiser's specific products or services by keyword for use within a search marketing campaign, according to one embodiment. As shown in the form for collecting information about the advertiser's specific products or services by keyword 3B00, an advertiser might enter keywords into the input box 3B10. Alternatively, the advertiser might elect to use an automated process using the input device 3B20 for finding keywords relevant to the advertiser's products, services, or messages. These keywords correspond to the variable k as described above.

FIG. 3C is a form for collecting information about the advertiser's target customers by geographic location for use within a search marketing campaign, according to one embodiment. As shown, the form for collecting information about the advertiser's target customers by geographic location 3C00 In particular, the advertiser might want to limit geographic reach to a particular country, or time zone, or region or state, or even a particular zip code. Such limitations may be used by a campaign optimizer engine 220, and/or any forecasting facilities and/or any campaign optimizer estimators. For example, when forecasting inventory of impressions corresponding to a particular target, one specific forecast of interest is the forecast of impressions expected to be presented to Internet users residing within the aforementioned limited geographic reach.

FIG. 3D is a form for collecting and reporting an inventory of keywords for use within a search marketing campaign, according to one embodiment. As shown, the form for collecting and reporting an inventory of keywords for use within a search marketing campaign 3D00 delivers a sampling of keywords together with estimated inventory of impressions (e.g. queries, searches, etc) in a tabular form 3D20. These estimates correspond to the variable freqᵢ as described above. The tabular form 3D20 serves to guide the advertiser to select keywords that have a sufficiency of inventory to impact the campaign.

FIG. 3E is a form for collecting information regarding spending limits within a search marketing campaign, according to one embodiment. As shown, the form for collecting information regarding spending limits 3E00 includes an area for a daily spending limit variable 3E10, an area for setting a maximum bid 3E20, an area for reporting estimated impressions 3E30, an area for reporting estimated clicks 3E40, an area for the campaign duration 3E50, an area for the frequency of bid estimate updates 3E60, and an area for a campaign name 3E65.

As may be understood, an advertiser may have many reasons to limit daily spending (e.g. to give the advertiser time to consider the performance of the campaign before spending more aggressively), and/or for setting a maximum bid (e.g. a higher cost for a click may violate an advertiser's target product or service delivery margin), and/or an advertiser may want to limit the duration of a campaign (e.g. so as to cap the total amount spent within the campaign period). Similarly, an advertiser may wish to limit, control or otherwise influence the frequency at which the campaign optimizer updates the bid amounts calculated and placed on behalf of the advertiser. According to one strategy, the campaign optimizer should update the bid of the advertiser frequently. The reasoning for this is that frequent updates improves forecasting accuracy in the face of fluctuating forecasts (e.g. the fluctuating forecast of the impression volumes). According to another strategy, as few as needed computing resources should be expended in order to achieve a sufficiently accurate forecast. Thus, the area for the frequency of bid estimate updates 3E60 may be used by the advertiser considering the relative importance of such strategies. As an example, consider the forecast-based case where advertiser A bids for the fourth slot of keyword k, knowing that, based on the daily forecast and daily winning bid price estimate, bidding that amount and at that frequency would exhaust the daily budget within an unacceptably short period of time. However, if the next day were to be a ‘slow day’ (i.e. a day with lower impression volume than previously forecasted), and if the campaign optimizer bid estimator (e.g. one of many possible campaign optimizer estimators 260) were scheduled to update only once in that day, advertiser A would continue to bid in the fourth slot and would not exhaust the daily budget. On the other hand, if the frequency of bid estimate updates were set to a higher frequency, then the campaign optimizer might increase advertiser A's bid to get a higher slot while still spending only within the spending limit of the campaign.

As may be understood, the campaign optimizer engine 220 may use an estimate of the price for each ad slot in various calculations. In one embodiment, bid estimates can be obtained by observing the exact values of the prices at the moment (also known as the bid landscape), or by using historical data (e.g. from history databases 272) about the price of each slot. In a preferred embodiment, the campaign optimizer estimators 260 (e.g. a price estimator component) is configured to observe the bid landscape in real-time or near real-time. Real-time or near real-time estimates improve time-wise accuracy of estimates and facilitate components of the campaign optimizer estimators 260 to react to changes in other advertisers' bids.

For example, following the previous example, when the campaign optimizer estimators 260 for the advertiser A calculates that ‘today’ is a slow day, it will try to bid for a higher slot, (e.g. the 2^{nd} slot). However, other advertisers might have done the same. So, bidding the “typical” price of the second slot still might not win in the auction. However, if the campaign optimizer estimators 260 observe the bid landscape, after a few iterations it will bid the “right” amount, thus winning the auction. To the contrary, using historical estimates instead of observing the current bid landscape to obtain estimates might lead to faster convergence and lower fluctuation in bids.

FIG. 3F is a form for collecting information regarding objectives and constraints within a search marketing campaign, according to one embodiment. As shown, the form for collecting information regarding objectives and constraints 3F00 includes an area for defining how much a click is worth 3F02, an area for defining how much a conversion is worth 3F04, an area for defining a maximum cost-per-click limit 3F05, an area for defining total budget override 3F10, an area for defining a target average cost-per-click 3F15, an area for defining a maximum clicks-per-day 3F20, an area for defining a minimum value of a moving average of ROI 3F25, an area for defining a minimum spend 3F30, an area for defining a minimum clicks-per-day limit 3F35, an area for defining a top k'th slots target 3F40, and an area for defining an aim for the top k'th slot target 3F45.

In various embodiments, advertising is placed by a variety of different types of advertisers (e.g. large advertisers, small advertisers, advertisers seeking brand advertising, advertisers seeking conversions, etc), where each type of advertiser is holding interests in a variety of campaign objectives and constraints. Therefore, embodiments allow advertisers to express a diverse set of objectives/constraints (e.g. using the form for collecting information regarding objectives and constraints 3F00). At the same time, the interface (e.g. form, screen device, etc) of such an embodiment might be sufficiently rich so as to assist the advertiser toward expressing only the most economically sensible constraints. Moreover, the interface (e.g. form, screen device, etc) of such an embodiment might be sufficiently rich so as to show estimated impact of various settings and/or changes in the campaign objectives and constraints.

Of course, there exists a wide range of possible campaign objectives and constraints. Strictly as an example, an objective function for an advertiser's advertising campaign might be a net utility value, expressed as the sum of the values of clicks received during some time period minus the cost of operating the campaign over that same time period. Another objective function for an advertiser's advertising campaign might comprise a return on investment value (ROI, also known as the return on advertising spend—ROAS). ROI is equal to the total value received divided by the cost. For example, the combination of this objective function with a minimum spend constraint might be useful for advertisers who only know their advertising budget as well as the relative (and not the absolute) value of a click from each keyword.

In addition to the above, any one of the constraints described below can be used within a calculation of the objective function of the optimization calculations. For example, an advertiser might try to maximize the number of clicks received subject to maximum cost-per-click constraints.

Some of these constraints might not be considered in calculations as hard constraints, when doing so would make the optimization problem infeasible. For example, if an advertiser wants at least one-hundred clicks per day and does not want to spend more than $100.00, there might not be a way to satisfy this advertiser's constraints given the cost of a winning bid at auction. Therefore, it is important to distinguish between constraints that can be imposed as hard constraints and the soft or “best effort” constraints, i.e. those constraints that the campaign optimizer engine 220 will try to satisfy, but cannot provide a guarantee that the constraint will be observed.

Strictly as an example, the list below discloses some constraints that an advertiser might want to express:
Max-CPC (see the area for defining a maximum cost-per-click limit 3F05): For each keyword, the maximum cost-per-click (CPC) is at most a given amount. This amount is generally the advertiser's value-per-click for the keyword (i.e. vᵢ).
Budget (see the area for defining total budget override 3F10): The amount to be spent.
Avg-CPC (see the area for defining a target average cost-per-click 3F15): For each keyword, the average cost-per-click (CPC) is at most a given amount.
Minimum moving average of ROI (see the area for defining a minimum value of a moving average 3F25). A soft target for ROI as averaged over the time period from the beginning of the campaign to the current time.
Min-spend (see the area for defining a minimum spend 3D30): The total spend-per-day is at least a given amount.
Max-click (see the area for defining a maximum clicks-per-day limit 3F20): The total/per-keyword number of clicks per day is at most a given amount.
Min-click (see the an area for defining a minimum clicks-per-day limit 3F35): The total/per-keyword number of clicks per day is at least a given amount.
Min-ROI: The campaign return-on-investment (ROI) is at least a given amount.
Top-k'th-slots (see the area for defining a top k'th slots target 3F40): For a keyword, bid only for one of the top k'th positions. This is typically useful for brand advertisers who often want to get one of the top three positions on a few important keywords in their campaign.
Aim-for-top k'th slot target (see area for defining an aim for top k'th slot target 3F45):

For a keyword, try to bid for slot k.

In the examples herein using the above constraints, the unit of time for which the constraints (such as budget) are set is one day (24 hours). It is possible and envisioned to generalize this to any other unit of time (e.g. a week, a month).

FIG. 3G is a form for displaying information regarding a plurality of search marketing campaigns, according to one embodiment. As shown, the form for displaying information regarding a plurality of search marketing campaigns 3G00 serves to display information about any number of campaigns. In some cases, an advertiser might prosecute a large number of different campaigns. Accordingly, a mechanism for quickly displaying information regarding a plurality of search marketing campaigns is provided, including a campaign search box 3G10 and including a table for displaying campaign information 3G20. More particularly, the campaign name field 3E65 (from FIG. 3E) might allow the advertiser to organize campaigns into any number of searchable, concurrently running (or paused) campaigns or sub-campaigns. Any given campaigns or sub-campaigns might be associated with a corresponding set of constraints selected from any one or more of the above campaign objectives and constraints.

### Algorithms of the Campaign Optimizer Engine

Various aspects and parameters embodied within the campaign optimizer engine 220 can be tuned to accommodate specific objectives and constraints. For example, campaign optimizer engine 220 might be tuned to maximize ROI subject to the constraint of a limit on spending per impression. Or, as another example, the campaign optimizer engine 220 might be tuned to optimize based on maximizing an objective function for return on investment, and given a constraint of a maximum cost-per-click limit 3F05 for specified keywords, and further given a constraint of a given daily spending limit (e.g. as described in the area for a daily spending limit variable 3E10). Performing optimization in such situations might include a marginal return on investment variable 210, which variable is used in calculations and decision-making that affects any transaction that contributes to the ROI calculation. In various embodiments a cost-utility representation (e.g. plot, graph, table, array, etc) is constructed within the campaign optimizer engine 220.

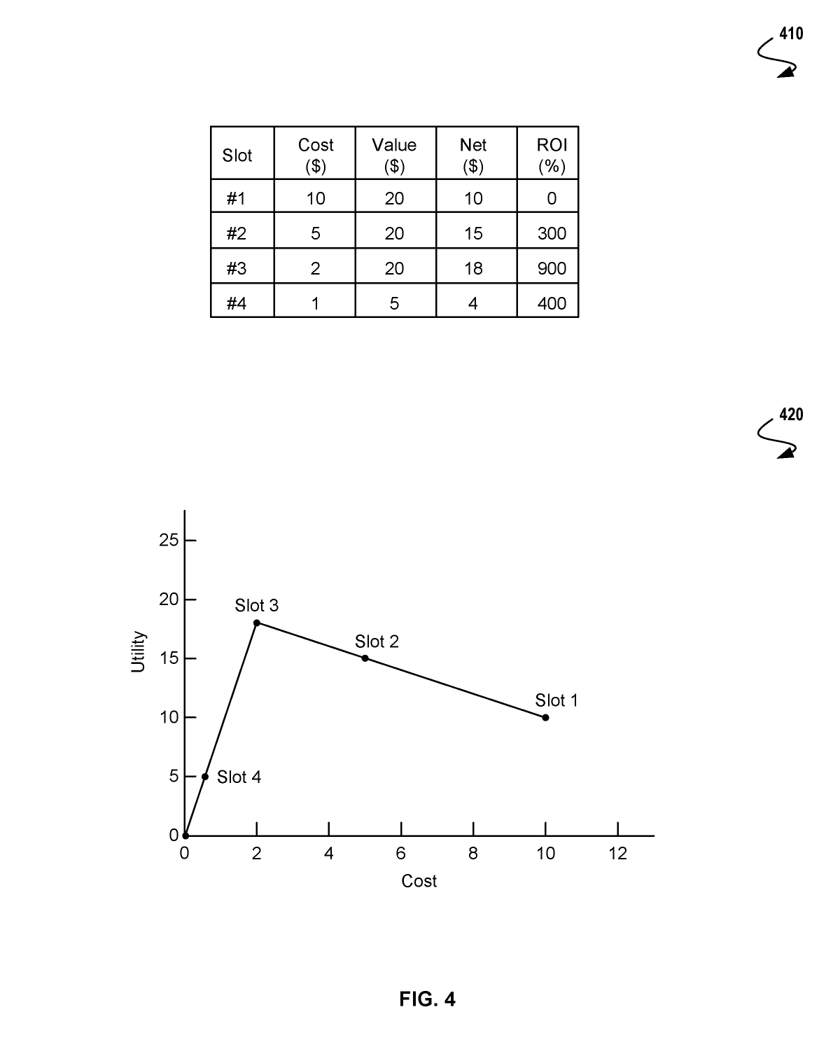

FIG. 4 is a comparison of cost versus utility for a particular keyword, according to one embodiment. As shown, chart 410 shows values corresponding to four slots, identified in the Slot column as slot #1, #2, #3, and #4. Also shown in the chart are columns for Cost, Value, Net and ROI as a percent. Specifically, in the Cost column are forecasted winning bid amounts for each of slots #1, #2, #3, and #4; and in the Value column are amounts as described by the advertiser (e.g. using a form or forms similar to the form shown in FIG. 3F) corresponding to the value to the advertiser of an advertisement in that slot.

Also shown is a cost-utility plot 420. In particular, the cost-utility plot 420 exemplifies the case where additional advertising spend does not necessarily return better Net amounts or better campaign results as measured by return on investment. That is, at least regarding the case of slot #2, bidding to secure this slot #2 requires more advertising spend than bidding to secure slot #3 (e.g. due to higher bidding competition for the more prominent slot), however it does not return commensurately more value (e.g. the corresponding click-through-rate CTR is not reliably higher). Thus, for optimizing instantaneous ROI, the advertiser should bid for slot #3, but not bid for slot #2. Additional examples follow.

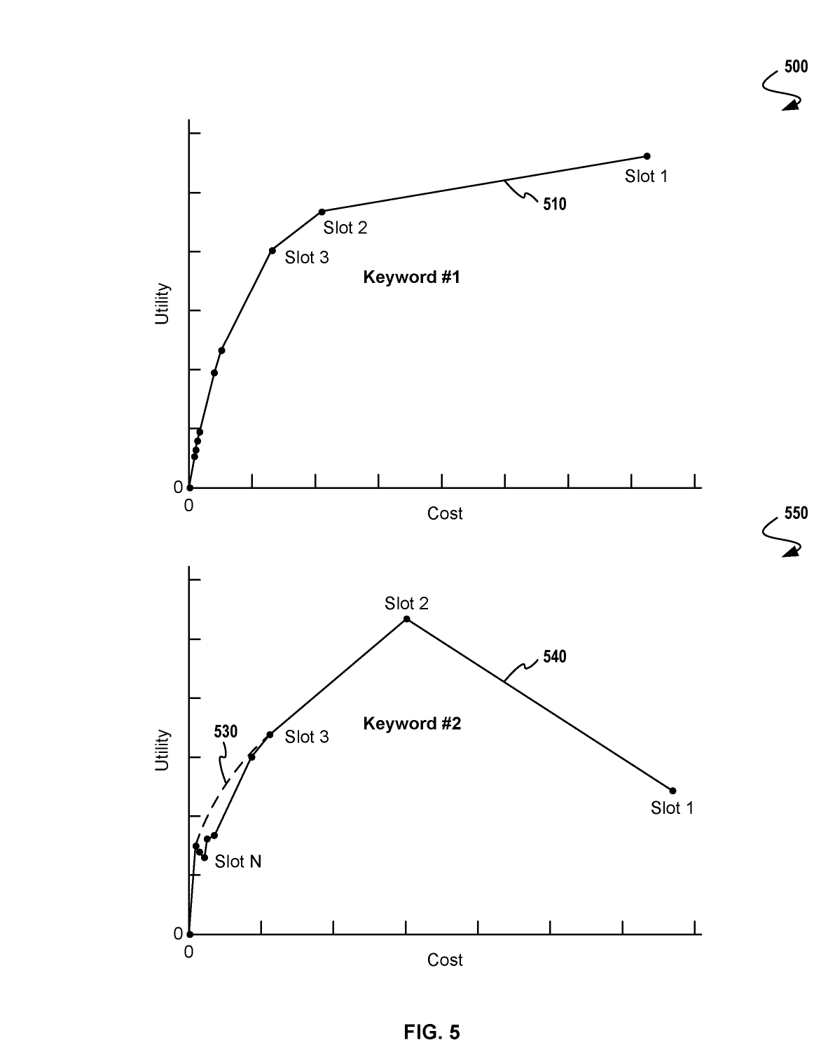

FIG. 5 is a plot of utility plotted against cost for particular keywords, according to one embodiment. As shown, the keyword #1 plot 500 plots the numeric value of utility as a function of the cost for keyword #1. The keyword #1 cost-utility curve 510 is monotonically increasing. Also shown is the keyword #2 plot 550, which plots the numeric value of utility as a function of the cost for keyword #2. The keyword #2 cost-utility curve 540 has regions of increase as well as regions of decrease.

In some embodiments, the campaign optimizer engine 220 plots a cost-utility curve for each keyword i, as follows: For each slot j, (e.g. Slot 1, Slot 2, Slot 3) let Nⱼ denote the expected number of clicks that the advertiser's ad would receive in a day if it is placed in the j'th slot of keyword i. Also, let costⱼ denote the price of each click in slot j for the advertiser, times Nⱼ. In other words, costⱼ is the total amount the advertiser has to pay to place his ad for keyword i in the j'th slot. Let utilityⱼ denote the value per click (see area for defining how much a click is worth 3F02) of the advertiser for keyword i times Nⱼ, minus costⱼ (utilityⱼ=vᵢNⱼ−costⱼ). In other words, utilityⱼ is the total expected net utility the advertiser derives from placing his ad for keyword i in slot j. The cost-utility graph connects the points (costⱼ, utilityⱼ) for all slots j, and the point (0, 0), which point represents no bid, and thus no cost data.

In mathematics, various conditions (i.e. calculable conditions known as the Karush-Kuhn-Tucker or KKT conditions) are necessary for a solution in nonlinear programming to be optimal. For checking such KKT conditions, it is convenient to represent the cost-utility plots as a continuously differentiable function. If a point on the cost-utility curve falls below the convex hall of other points on the curve, it means that bidding for the corresponding slot is dominated by a combination of other slots. Therefore, construction of the graph may remove all such slots (i.e. points on the cost-utility curve that fall below the convex hall of other points on the curve) from the graph and connect each remaining point on the curve to the next remaining point. Such a case is shown in the keyword #2 plot 550 at convex hall bridge 530 between the point for Slot 2 and the point for Slot N. The resulting graph represents a continuously differentiable convex function that can be used in representing an optimization problem than can be solved using linear programming optimization techniques. In other embodiments, mathematical curve-fitting techniques might be used to represent the graph as a continuously differentiable function.

### Conditions for Optimal Budget Allocation

In mathematics, again referring to the Karush-Kuhn-Tucker or KKT conditions as applied to the optimization problem of optimizing budget allocations, it follows that when the budget of the advertiser is allocated optimally across keywords, different keywords will share roughly equal marginal returns on investment. This notion provides the basis for how the campaign optimizer engine 220 decides which slots it should bid on, and at what bid amount 280. Various exemplary embodiments maintain a target marginal return on investment variable 210 (also referred to herein as λ), and for each keyword, the campaign optimizer engine 220 selects a slot from an array of opportunity slots 230 formed from individual opportunity slots (e.g. OS₁-OS_{N}) from the corresponding aforementioned keyword plots (e.g. keyword #1 plot 500 and keyword #2 plot 550) such that the slope from that point to the next point (i.e. corresponding to a more prominent slot) is less than λ and the slope from the previous point (i.e. corresponding to a less prominent slot) to that point is greater than or equal to λ.

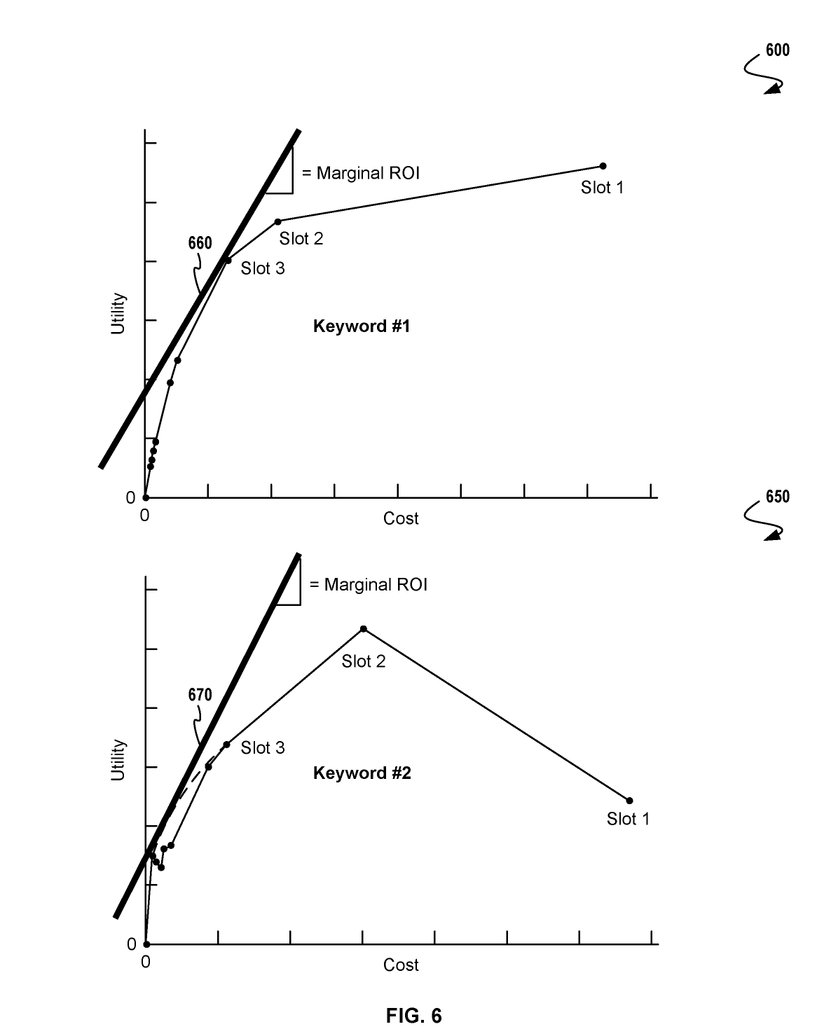

FIG. 6 is a plot of utility plotted against cost for particular keywords and showing a marginal return on investment metric as a slope, according to one embodiment. As shown, the plot 600 includes a marginal ROI slope line for keyword #1 660 and the plot 650 includes a marginal ROI slope line for keyword #2 670.

In general, increasing λ leads to bidding on lower slots and therefore lower total spend, and conversely, decreasing λ leads to higher total spend. Therefore, the total spend can be controlled by changing λ to either exactly meet the daily budget, or bidding at the highest utility slot for each keyword.

### Computing the Bid Amount

Once the slots for which the campaign optimizer engine 220 should bid on behalf of the advertiser are identified, the bid amount 280 is calculated and provided to a bidding facility 250. It can be seen that it is possible that a bid of any arbitrary amount might result in winning the bid and thus securing the desired slot for the advertiser. However, in some cases (e.g. those embodiments that use historical results) the effect of one bid may affect all subsequent bids, and thus may affect the convergence properties of the bidding algorithm. In other embodiments, bid amount 280 is calculated using a pragmatic bidding agent formula. In prosaic description, for each keyword, bid the value such that if the next (more prominent, generally more expensive) slot is offered at the price equal to the bid, the slope between the current slot and the next slot is precisely the target marginal ROI λ. This rule leads to the following bidding formula:

$$bid = \frac{C T {R}_{current}}{C T {R}_{next}} \times {price}_{current} + ( 1 - \frac{C T {R}_{current}}{C T {R}_{next}} ) \times \frac{{v}_{i}}{1 + λ} \qquad ( Equation 1 )$$

### Iterations of the Campaign Optimizer Engine

In embodiments, the campaign optimizer engine 220 performs initialization and set-up tasks and performs calculations periodically (e.g. with a frequency influenced by the frequency of bid estimate updates 3E60), and might perform one or more of the following operations.

### Initialization Tasks

1. Allocate a marginal return on investment variable 210 (i.e. λ).
2. Initialize the marginal return on investment variable 210.

### Iteration Tasks

1. Decide (based on the history and forecasts) if the advertiser is currently under/overspending the budget (e.g. as described in the area for a daily spending limit variable 3E10). If overspending, then increase λ; if underspending, then decrease λ. The value of λ may be decreased to zero, but λ may not be decreased to a negative number.
2. From the cost-utility curves described above, identify optimal slots for each keyword given B.
3. Bid according to bidding formula shown in Equation 1.

Various embodiments of a campaign optimizer engine 220 employ parameter-based techniques to measure if the advertiser is overspending or underspending. Similarly, various embodiments of a campaign optimizer engine 220 employ parameter-based techniques to determine how much to change λ at each iteration. These parameters can be fine-tuned depending on the available data and specifics of the market.

### Iterative Increment Convergence

For example, if the rate of spend follows the same pattern each day, use historical data to compute an expectation of the percentage of budget that the advertiser must have spent during each hour of the day, and measure under/overspend by comparing the fraction of budget spent against the historical data. An alternative technique for adjusting the value of λ is to decrease or increase it by a value ε, which value ε is at least initially selected to be a small value. In still other alternative embodiments, the amount that λ is increased or decreased can depend on how much the advertiser is over/underspending.

### Convergence Based on a Forecast Value

In other embodiments of a campaign optimizer engine 220, instead of gradually increasing/decreasing the value of λ until reaching a point of equilibrium where the rate of spending is consistent with the daily budget, some techniques use forecasts to directly jump to the “forecasted correct value” for value of λ. In some cases, this technique might converge faster than iterative increment convergence, however rapid convergence to equilibrium using the technique of convergence based on a forecast value relies on the accuracy of the underlying forecasts.

### Optimization Using Lagrangian Multipliers

The techniques described above can be though to be equivalent to first scaling down all the values of the advertiser by a factor of 1+λ, and then using the pragmatic agent formula of Equation 1 on the resulting set of values. An alternative interpretation of this is to solve the optimization problem using Lagrangian multipliers and Lagrangian relaxations.

### Incorporating Other Constraints

Avg-CPC (see 3F15): The Avg-CPC constraint can be handled similar to the Max-CPC constraint, except the amount of the Max-CPC should be updated depending on the price of the clicks received so far. For example, if at the beginning of the day the advertiser receives clicks cheaper than the maximum average CPC, the effective Max-CPC will be increased later in the day to an amount that would keep the average below the maximum allowed.
Min-spend (see 3F30): This constraint is similar to the budget constraint, except that the direction of the inequality is reversed. Using the Lagrangian relaxation approach, this optimization problem can be solved as follows: Keep track of a Lagrangian multiplier, λ₁, initialized at 0 and increased (decreased) every time the campaign optimizer detects that the advertiser is spending at a rate that would lead to a total daily spending less (more) than the Min-spend. The campaign optimizer then scales up all the values by a factor of 1+λ₁, and uses the pragmatic agent formula. The campaign optimizer engine 220 performs checks to explicitly enforce the Max-CPC constraints, i.e. never allocate a slot to the advertiser if the price is more than the Max-CPC, even if the scaled up value for that slot is more than the price.
Max-clicks (see 3F20): Again, using the Lagrangian relaxation technique, this constraint can be handled as follows: The campaign optimizer engine 220 maintains a Lagrangian multiplier λ₂, and increases (decreases) it every time it detects that the advertiser is receiving clicks at a rate that would lead to more (fewer) daily clicks than Max-clicks.

This embodiment then modifies values by subtracting λ₂ from each value, and uses the pragmatic agent formula for bidding operations.
Min-click (see 3F35): Similar to Max-click, except the Lagrangian multiplier λ₃ is added to the values and then the pragmatic agent formula is used for bidding operations. In this embodiment, the campaign optimizer engine 220 enforces the Max-CPC constraint.
Min-ROI (see 3F25): This constraint can be handled in a manner similar to Avg-CPC. At the beginning of the day, the effective Max-CPC for each keyword is the value of that keyword scaled down by a factor of Min-ROI. Later in the day, as the advertiser receives clicks cheaper than the effective Max-CPC, it can increase the Max-CPC in a way that would keep the total moving average ROI above the minimum allowed.
Top-k-slots (see 3F40): This constraint can be handled by modifying only bidding for one of the top k slots (to the extent that such top slots exist).
Aim-for-slot-k (see 3F45): In this embodiment, the campaign optimizer engine bids only for the k'th slot (or does not bid at all) if the price of this slot is less than the effective Max-CPC.

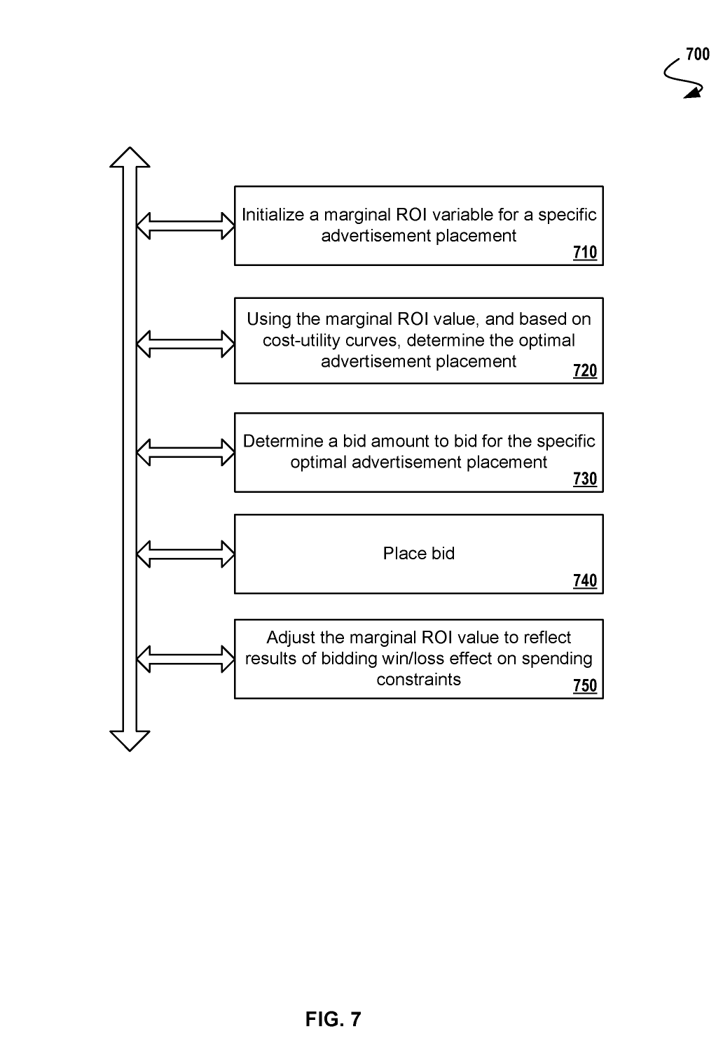

FIG. 7 is a flowchart of a method for use within a system for automatic campaign optimization for online advertising using return on investment metrics, according to one embodiment. As an option the present system for automatic campaign optimization for online advertising using return on investment metrics 700 may be implemented in the context of the architecture and functionality of FIG. 1 through FIG. 6, or it may be implemented in any environment. As shown, the operations may be executed in any order, so long as the data requirements for execution are satisfied. Purely as an illustrative example, using one possible sequential flow, the system for automatic campaign optimization for online advertising using return on investment metrics 700 commences to initialize a marginal return on investment variable 210 for a specific advertisement placement (at 710), and proceeds to determine the optimal advertisement placement (e.g. Slot1, Slot2, Slot3, etc) based on (1) the marginal ROI value, (2) cost-utility curves, and (3) possibly using an opportunity slot selector 235 (see operation 720). Once an optimal advertisement placement has been determined, the operations shown serve to determine a bid amount to bid for the specific optimal advertisement placement (see operation 730). The determination of a bid amount to bid for the specific optimal advertisement placement might use the pragmatic bidding agent formula, as described above, or the determination of a bid amount to bid for the specific optimal advertisement placement might use any other bidding technique.

Once a bid amount has been determined (at 730), a bid is placed (at 740), possibly using a biding agent 240 through a bidding facility 250. Then (at 750), on the basis of the result of the auction using the bid amount 280, adjust the marginal ROI value to reflect the results of the bidding win or loss effect on spending constraints, possibly using one or more components of the campaign optimizer estimators 260. Of course, as earlier described, the operation 750 might use any one or more components of the campaign optimizer estimators 260 which in turn might use data (e.g. click-through rates, auction prices, forecasted volumes) from a clearing house engine 295. Further, the execution of operation 750 might use any one or more components of the campaign optimizer estimators 260, such as using data from a valuation discovery engine 285, which in turn might employ one or more conversion tracking subsystems 270.

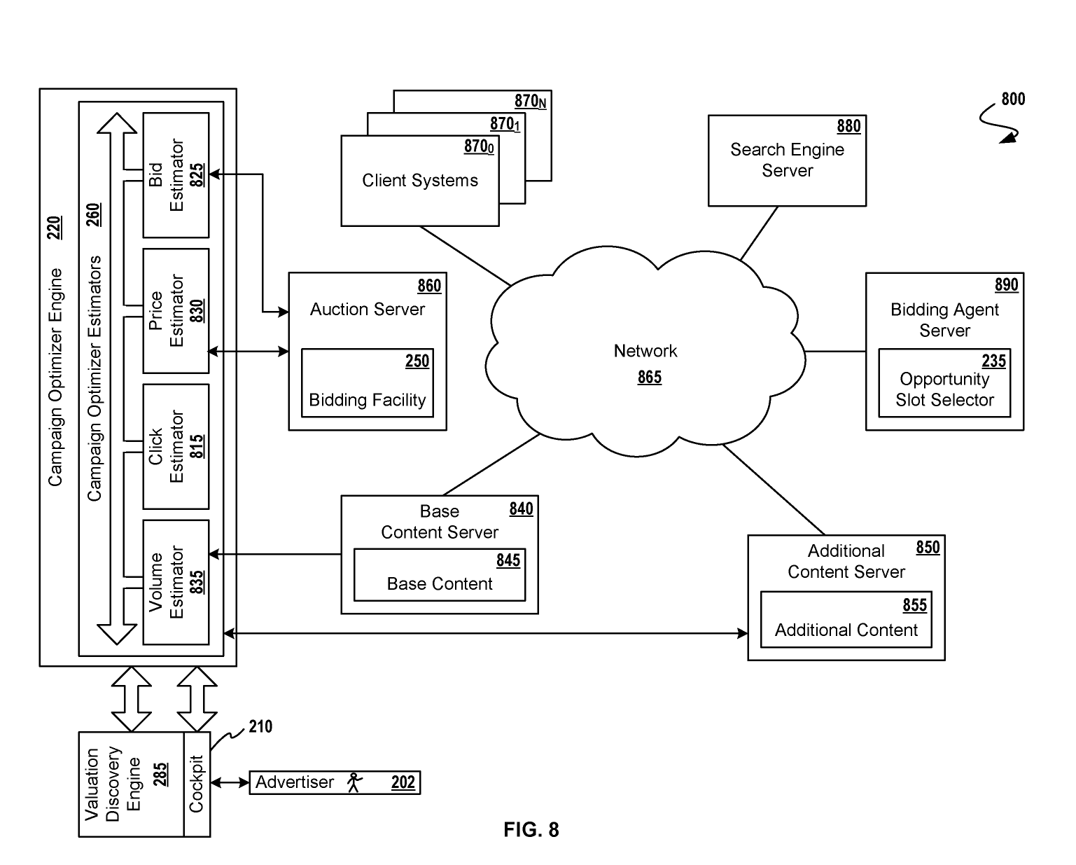

FIG. 8 is a block diagram of a system for automatic campaign optimization for online advertising using return on investment metrics, according to one embodiment. As an option the present system for automatic campaign optimization for online advertising using return on investment metrics 800 may be implemented in the context of the architecture and functionality of FIG. 1 through FIG. 7, or it may be implemented in any environment. As shown, the system for automatic campaign optimization for online advertising using return on investment metrics 800 comprises a campaign optimizer engine 220 cooperatively in communication with a network of computers through network 865. The network of computers comprises a base content server 840 hosting base content 845, an additional content server 850 hosting additional content 855, a search engine server 880, and a plurality of client systems 870, labeled as 870₀-870_{N}. Also shown is a bidding agent server 890 comprising an opportunity slot selector 235, and an auction server 860 comprising a bidding facility 250.

Thus, the system for automatic campaign optimization for online advertising using return on investment metrics 800 serves to implement a computer-implemented method for optimizing quantitative performance in an online advertising campaign having a finite campaign period and a finite campaign spending budget. Moreover, the present system uses a bidding facility 250 for bidding on a plurality of ranked advertising slots for a particular advertising opportunity. In exemplary embodiments, the campaign optimizer engine 220 serves for setting, in memory, a value for a marginal return on investment variable, and then selecting one advertising slot upon which to bid (selected from among the plurality of ranked advertising slots). In some embodiments, the selection is based on at least in part a history of winning bids for the plurality of ranked advertising slots (e.g. from cost-utility curve 510 or from cost-utility curve 540), and based on at least in part the value of the marginal return on investment variable. A bidding agent server 890 possibly comprising an opportunity slot selector 235 may be used to select the opportunity. Further, the campaign optimizer engine 220 serves for calculating a bid amount corresponding to the selected opportunity slot. The bid amount might be calculated using any one or more techniques, and such techniques might employ any one or more campaign optimizer estimators 260, which in turn might use a volume estimator 835, a click estimator 815, a price estimator 830, and/or a bid estimator 825. The auction server 860 serves for hosting a bidding facility 250 for bidding on the selected advertising slot using the calculated bid amount. Based on the results of the bidding at auction, the campaign optimizer engine 220 performs operations for changing (or leaving unchanged) the value of the marginal return on investment variable 210.

Now in alternative embodiments, and as earlier described, the campaign optimizer engine 220 may allocate and initialize a value for a marginal return on investment variable 210. This variable might be initialized to zero, or it might be set to a value equal to the slope between two points within of a cost-utility series of at least three points (e.g. from cost-utility curve 510 or from cost-utility curve 540).

In some embodiments, the campaign optimizer engine 220 may perform any number of calculations and/or apply heuristics for selecting an advertising slot upon which to bid. Strictly as an example, such calculations and/or heuristics may include calculating a prophetic marginal return value for each of the plurality of ranked opportunity slots, and then selecting an opportunity slot corresponding to an increasing marginal return value. Similarly, the campaign optimizer engine 220 may perform any number of calculations and/or apply heuristics for calculating the bid amount corresponding to the selected opportunity slot. In some cases, a bid amount is determined by merely using a known winning bid amount, or the bid amount might be calculated using a pragmatic bidding agent formula.

In some embodiments, changing the value of the marginal return on investment variable may be based on the results of the bidding, and such techniques include increasing the value of the marginal return on investment variable when continued unchanged bidding is forecasted to overspend the finite campaign spending budget by the end of the finite campaign period. Similarly, such techniques include decreasing the value of the marginal return on investment variable when continued unchanged bidding is forecasted to underspend the finite spending budget by the end of the finite campaign period. Of course it is reasonable and exemplary that in some cases the value of the marginal return on investment variable reaches an equilibrium and thus remains unchanged over successive iterations.

In some embodiments, determining the selected opportunity slot upon which to bid is based at least in part on a history of winning bids for a particular advertising slot, and some corresponding techniques comprise considering a history of winning bids where the winning bid was less than some particular bid value. By the same token, some corresponding techniques comprise considering a history of winning bids where the winning bid was greater than some particular bid value. Still other techniques comprise heuristics for considering a history of winning bids in auctions pertaining to a particular slot rank. For example, at one moment in time, a cost-utility curve might exhibit a sharp increase as approaching a particular slot rank, however such a sharp increase might have been merely the result of some anomalous bidding or spot market condition, and a broader, historical view might result in a less sharp, less anomalous curve.

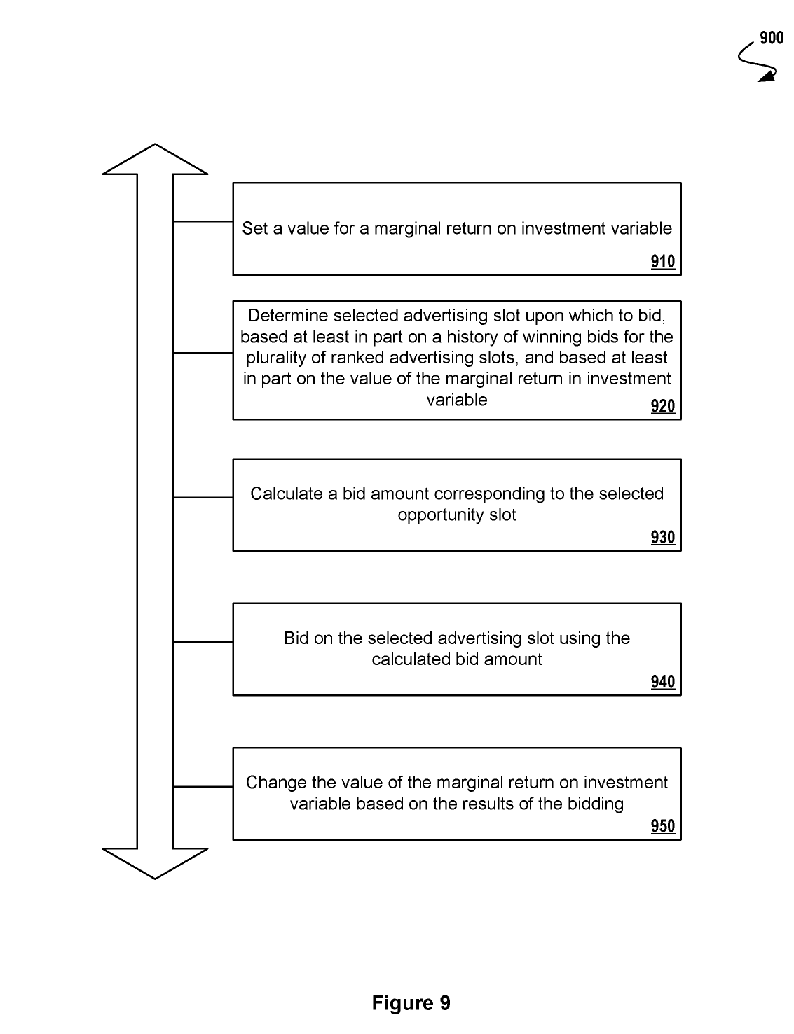

FIG. 9 is a flowchart of a method for optimizing quantitative performance in an online advertising campaign using return on investment metrics, according to one embodiment. As an option the present method for automatic campaign optimization for online advertising using return on investment metrics 900 may be implemented in the context of the architecture and functionality of FIG. 1 through FIG. 8, or it may be implemented in any environment. As shown the operations describe a method for optimizing quantitative performance in an online advertising campaign having a finite campaign period and a finite campaign spending budget within a system that comprises a bidding facility for bidding on a plurality of ranked advertising slots for a particular advertising opportunity. The operations may be executed in any order, so long as the data requirements for execution are satisfied. The method comprises setting a value for a marginal return on investment variable (see operation 910); determining a selected advertising slot upon which to bid, based at least in part on a history of winning bids for the plurality of ranked advertising slots, and based at least in part on the value of the marginal return on investment variable (see operation 920); calculating a bid amount corresponding to the selected opportunity slot (see operation 930); bidding on the selected advertising slot using the calculated bid amount (see operation 940); and changing the value of the marginal return on investment variable based on the results of the bidding (see operation 950).

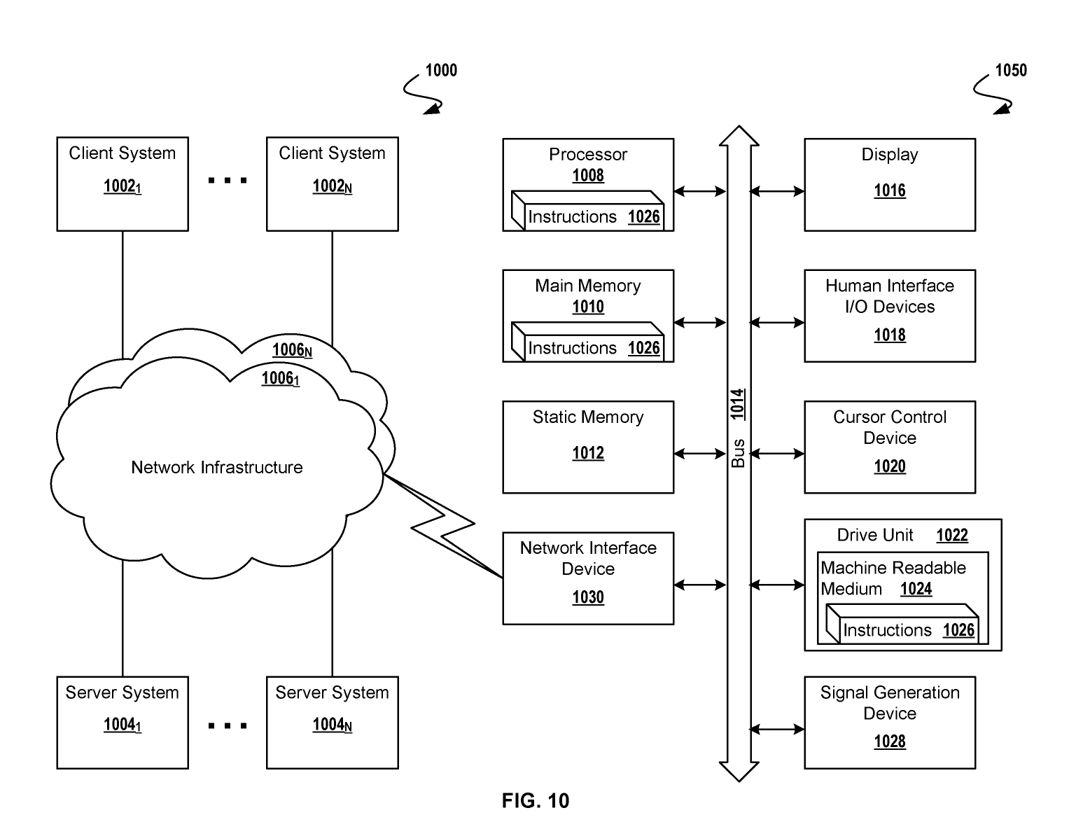

FIG. 10 is a diagrammatic representation of a network 1000, including nodes for client computer systems 1002₁ through 1002_{N}, nodes for server computer systems 1004₁ through 1004_{N}, nodes for network infrastructure 1006₁ through 1006_{N}, any of which nodes may comprise a machine 1050 within which a set of instructions for causing the machine to perform any one of the techniques discussed above may be executed. The embodiment shown is purely exemplary, and might be implemented in the context of one or more of the figures herein.

Any node of the network 1000 may comprise a general-purpose processor, a digital signal processor (DSP), an application specific integrated circuit (ASIC), a field programmable gate array (FPGA) or other programmable logic device, discrete gate or transistor logic, discrete hardware components, or any combination thereof capable to perform the functions described herein. A general-purpose processor may be a microprocessor, but in the alternative, the processor may be any conventional processor, controller, microcontroller, or state machine. A processor may also be implemented as a combination of computing devices (e.g. a combination of a DSP and a microprocessor, a plurality of microprocessors, one or more microprocessors in conjunction with a DSP core, or any other such configuration, etc).

In alternative embodiments, a node may comprise a machine in the form of a virtual machine (VM), a virtual server, a virtual client, a virtual desktop, a virtual volume, a network router, a network switch, a network bridge, a personal digital assistant (PDA), a cellular telephone, a web appliance, or any machine capable of executing a sequence of instructions that specify actions to be taken by that machine. Any node of the network may communicate cooperatively with another node on the network. In some embodiments, any node of the network may communicate cooperatively with every other node of the network. Further, any node or group of nodes on the network may comprise one or more computer systems (e.g. a client computer system, a server computer system) and/or may comprise one or more embedded computer systems, a massively parallel computer system, and/or a cloud computer system.

The computer system 1050 includes a processor 1008 (e.g. a processor core, a microprocessor, a computing device, etc), a main memory 1010 and a static memory 1012, which communicate with each other via a bus 1014. The machine 1050 may further include a display unit 1016 that may comprise a touch-screen, or a liquid crystal display (LCD), or a light emitting diode (LED) display, or a cathode ray tube (CRT). As shown, the computer system 1050 also includes a human input/output (I/O) device 1018 (e.g. a keyboard, an alphanumeric keypad, etc), a pointing device 1020 (e.g. a mouse, a touch screen, etc), a drive unit 1022 (e.g. a disk drive unit, a CD/DVD drive, a tangible computer readable removable media drive, an SSD storage device, etc), a signal generation device 1028 (e.g. a speaker, an audio output, etc), and a network interface device 1030 (e.g. an Ethernet interface, a wired network interface, a wireless network interface, a propagated signal interface, etc).

The drive unit 1022 includes a machine-readable medium 1024 on which is stored a set of instructions (i.e. software, firmware, middleware, etc) 1026 embodying any one, or all, of the methodologies described above. The set of instructions 1026 is also shown to reside, completely or at least partially, within the main memory 1010 and/or within the processor 1008. The set of instructions 1026 may further be transmitted or received via the network interface device 1030 over the network bus 1014.

It is to be understood that embodiments of this invention may be used as, or to support, a set of instructions executed upon some form of processing core (such as the CPU of a computer) or otherwise implemented or realized upon or within a machine- or computer-readable medium. A machine-readable medium includes any mechanism for storing or transmitting information in a form readable by a machine (e.g. a computer). For example, a machine-readable medium includes read-only memory (ROM); random access memory (RAM); magnetic disk storage media; optical storage media; flash memory devices; electrical, optical, acoustical or other form of propagated signals (e.g. carrier waves, infrared signals, digital signals, etc); or any other type of media suitable for storing or transmitting information.

We claim:

1. A computer-implemented method for optimizing quantitative performance in an online advertising campaign having a finite campaign period and a finite campaign spending budget within a system that comprises a bidding facility for bidding on a plurality of ranked advertising slots for a particular advertising opportunity, the method comprising:
setting, in memory, a value for a marginal return on investment variable;
determining, at a server, a selected advertising slot upon which to bid, based at least in part on a history of winning bids for the plurality of ranked advertising slots, and based at least in part on the value of the marginal return on investment variable;
calculating, in a processor, a bid amount corresponding to the selected opportunity slot;
bidding, at a bidding server, on the selected advertising slot using the calculated bid amount; and
changing the value of the marginal return on investment variable based on the results of the bidding.

2. The method of claim 1, wherein the setting a value for a marginal return on investment variable comprises at least one of, setting to zero, setting the value equal to the slope between two points within of a cost-utility series of at least three points.

3. The method of claim 1, wherein determining the selected advertising slot upon which to bid comprises calculating a prophetic marginal return value for each of the plurality of ranked opportunity slots and then selecting an opportunity slot corresponding to an increasing marginal return value.

4. The method of claim 1, wherein calculating the bid amount corresponding to the selected opportunity slot is determined by at least one of, a known winning bid amount, a bid amount calculated using a pragmatic bidding agent formula.

5. The method of claim 1, wherein changing the value of the marginal return on investment variable based on the results of the bidding includes increasing the value of the marginal return on investment variable when continued unchanged bidding is forecasted to overspend the finite campaign spending budget by the end of the finite campaign period.

6. The method of claim 1, wherein changing the value of the marginal return on investment variable based on the results of the bidding includes decreasing the value of the marginal return on investment variable when continued unchanged bidding is forecasted to underspend the finite spending budget by the end of the finite campaign period.

7. The method of claim 1, wherein determining the selected opportunity slot upon which to bid is based at least in part on a history of winning bids for a particular advertising slot comprises considering a history of winning bids under a particular constant bid value.

8. The method of claim 1, wherein determining the selected opportunity slot upon which to bid, based at least in part on a history of winning bids for a particular advertising slot comprises considering a history of winning bids over a particular calculated bid value.

9. The method of claim 1, wherein determining the selected opportunity slot upon which to bid comprises considering a history of winning bids over a particular slot rank.

10. The method of claim 1, wherein determining the selected opportunity slot upon which to bid comprises targeting a particular slot rank.

11. A system for optimizing quantitative performance in an online advertising campaign having a finite campaign period and a finite campaign spending budget within a system that comprises a bidding facility for bidding on a plurality of ranked advertising slots for a particular advertising opportunity, comprising:
a module for setting, in memory, a value for a marginal return on investment variable;
a module for determining, at a server, a selected advertising slot upon which to bid, based at least in part on a history of winning bids for the plurality of ranked advertising slots, and based at least in part on the value of the marginal return on investment variable;
a module for calculating, performed by a computer, a bid amount corresponding to the selected opportunity slot;
a module for bidding, at a bidding server, on the selected advertising slot using the calculated bid amount; and
a module for changing the value of the marginal return on investment variable based on the results of the bidding.

12. The system of claim 11, wherein the setting a value for a marginal return on investment variable comprises at least one of, setting to zero, setting the value equal to the slope between two points within of a cost-utility series of at least three points.

13. The system of claim 11, wherein determining the selected advertising slot upon which to bid comprises calculating a prophetic marginal return value for each of the plurality of ranked opportunity slots and then selecting an opportunity slot corresponding to an increasing marginal return value.

14. The system of claim 11, wherein calculating the bid amount corresponding to the selected opportunity slot is determined by at least one of, a known winning bid amount, a bid amount calculated using a pragmatic bidding agent formula.

15. The system of claim 11, wherein changing the value of the marginal return on investment variable based on the results of the bidding includes increasing the value of the marginal return on investment variable when continued unchanged bidding is forecasted to overspend the finite campaign spending budget by the end of the finite campaign period.

16. The system of claim 11, wherein changing the value of the marginal return on investment variable based on the results of the bidding includes decreasing the value of the marginal return on investment variable when continued unchanged bidding is forecasted to underspend the finite spending budget by the end of the finite campaign period.

17. The system of claim 11, wherein determining the selected opportunity slot upon which to bid is based at least in part on a history of winning bids for a particular advertising slot comprises considering a history of winning bids under a particular constant bid value.

18. The system of claim 11, wherein determining the selected opportunity slot upon which to bid, based at least in part on a history of winning bids for a particular advertising slot comprises considering a history of winning bids over a particular calculated bid value.

19. The system of claim 11, wherein determining the selected opportunity slot upon which to bid comprises considering a history of winning bids over a particular slot rank.

20. The system of claim 11, wherein determining the selected opportunity slot upon which to bid comprises targeting a particular slot rank.
